(19) United States
(12) Patent Application Publication
(10) Pub. No.: US 2006/0063537 A1
(43) Pub. Date: Mar. 23, 2006

(54) Method and apparatus for determining position of mobile communication terminal

(76) Inventors: Young-Sik Lee, Seoul (KR); Dong-Jun Kum, Anyang-si (KR)

Correspondence Address: DILWORTH & BARRESE, LLP, 333 EARLE OVINGTON BLVD., UNIONDALE, NY, 11553, US

(21) Appl. No.: 11/231,144

(22) Filed: Sep. 20, 2005

(30) Foreign Application Priority Data
Sep. 20, 2004 (KR) 75265/2004

(51) Int. Cl. H04Q 7/20

(52) U.S. Cl. 455/456.1

(57) ABSTRACT

Disclosed are a method and an apparatus for determining the position of a mobile communication terminal. A location server for determining a position of the mobile communication terminal in an Assisted Global Positioning System (AGPS), the location server including a position calculating algorithm, and a base station information database, wherein the location server executes the position calculating algorithm when a base station measurement signal provided by the mobile communication terminal is received and reads x-coordinate values and y-coordinate values of corresponding base stations from the base station information database and determines an x-coordinate value of the mobile communication terminal by calculating a mean value of the x-coordinate values of the base stations and determines a y-coordinate value of the mobile communication terminal by calculating a mean value of the y-coordinate values of the base stations.

### PRIORITY

This application claims priority to an application entitled “Method and Apparatus for Determining Position of Mobile Communication Terminal” filed in the Korean Intellectual Property Office on Sep. 20, 2004 and assigned Serial No. 2004-75265, the contents of which are incorporated herein by reference.

### BACKGROUND OF THE INVENTION

1. Field of the Invention

The present invention relates to an apparatus and a method for determining a position of a mobile communication terminal in a mobile communication system, and more particularly to an apparatus and a method for determining a position of a mobile communication terminal in a location server (corresponding to a position determination entity (PDE) in a CDMA scheme and a serving mobile location center (SMLC) in a WCDMA scheme) necessary for an assisted global positioning system (AGPS) system.

2. Description of the Related Art

There are a variety of schemes for determining the position of a mobile communication terminal in a mobile communication system. For example, one such scheme is known as an Assistance Global Positioning System (AGPS) scheme. for the AGPS scheme determines the position of the mobile communication terminal based on a GPS pseudo range by receiving assistance information from a location server in order to reduce a time required for obtaining a GPS satellite signal by the mobile communication terminal. Another scheme is known as an Advanced Forward Link Trilateration (AFLT) scheme. The AFLT scheme determines the position of the mobile communication terminal using triangulation of information corresponding to a base station pilot phase measured by the mobile communication terminal.

When it is impossible for a Global Positioning System (GPS) system to measure the position of a mobile communication terminal, the position of the mobile communication terminal is determined using a time difference of arrival (TDOA) scheme. The TDOA scheme uses a difference between times in which most of base station pilot signals arrive (based on a relative difference between times in which radio waves from two base stations arrive) to calculate the mobile communication terminal's position.

However, the TDOA scheme cannot precisely calculate the position of a mobile communication terminal and is likely to produce errors thus increasing a likelihood of position determination failure. These positioning errors include a non-line-of-sight (NLOS) error, a repeater time delay error, a multi-path error, etc.

Other schemes for determining the position of the mobile communication terminal include a Time Of Arrival (TOA) scheme. In the TOA scheme, information is acquired for determining the position of the mobile communication terminal by measuring time of radio wave delivery.

Other schemes for measuring the position of a mobile communication terminal include a scheme of using pilot signal strength, a scheme of returning base station sector center information or base station coordinates as the position coordinates of the mobile communication terminal when the position determination of the mobile communication terminal has failed, and a scheme of using prior knowledge coordinates of the mobile communication terminal.

According to the TOA scheme information, the propagation time of a radio wave from a base station is calculated and a position of the mobile communication terminal is determined by using the wave signal to calculate a corresponding distance between time of the signal to calculate a corresponding distance between the base station and the mobile communication terminal.

According to the scheme of using the pilot signal strength, a signal strength model according to a distance is formed based on a principle in which pilot signal strength varies with a distance, thereby determining the position of the mobile communication terminal.

According to the scheme of returning base station sector center information or base station coordinates as the position coordinates of the mobile communication terminal, sector center information of a serving base station is returned or coordinates of the serving base station are used as the coordinates of the mobile communication terminal and returned when the position determination of the mobile communication terminal has failed.

The pilot signal strength scheme, the TDOA scheme and the schemes which use prior knowledge coordinates of the mobile communication terminal, are disclosed in U.S. Pat. No. 6,429,815, which relates to a method for determining coordinates of a search center for generating acquisition assistance data and a search window size of reflecting errors for the position of the coordinates.

One of the four schemes described above is employed when the initial position of the mobile communication terminal used for generating assistance information is calculated according to the AGPS scheme or when the position of the mobile communication terminal cannot be determined by the GPS.

However, in the TDOA scheme and the TOA scheme, a case in which a measurement error value is very large or a case in which a solution cannot be found frequently occurs due to the NLOS error, the repeater time delay error, and the multi-path error. In addition, although a variety of algorithms are considered in order to reduce or remove errors (including the NLOS error and the repeater time delay error) having a bias characteristic described above, such algorithms require considerable calculation which can waste system resources and can cause the system to become unstable.

The scheme of using pilot signal strength calculates the position of the mobile communication terminal using models of pilot signal strength according to distance. In this scheme, the performance depends upon the models and the location (e.g., being located in a city or a rural area).

The scheme of returning the base station coordinates or the sector center information of the serving base station has different errors based on the size of a coverage area of the base station. The scheme can have a maximum position error of several Kms. As described above, as the position of the mobile communication terminal is inaccurately determined, values of “SV_CODE_PH”, “SV_CODE_PH_WIN”, “DOPPLERO”, and “DOPPLER_WIN” included in acquisition assistance data becomes inaccurate. Therefore, as the values become more inaccurate, a probability in which the mobile communication terminal does not obtain a GPS satellite signal increases.

As described above, in the AGPS system, the initial position of the mobile communication terminal used for generating acquisition assistance data must be determined such that a position calculation amount can be less, and position errors can be maintained in a stable and reliable degree. However, the conventional schemes have problems in that position error values are relatively large and unstable.

### SUMMARY OF THE INVENTION

Accordingly, the present invention has been made to solve the above-mentioned problems occurring in the prior art, and an object of the present invention is to provide a location server capable of improving stability and reliability of determining a position of a mobile communication terminal in an AGPS system and a method thereof.

An object of the present invention is to provide a location server capable of reliably determining an initial position of a mobile communication terminal to be used for generating acquisition assistance data for obtaining GPS satellite information by the mobile communication terminal in an AGPS system and a method thereof.

To accomplish the above objects, there is provided a location server for determining a position of a mobile communication terminal in an assisted global positioning system (AGPS), the location server including a position calculating algorithm, and a base station information database, wherein the location server executes the position calculating algorithm when a base station measurement signal provided by the mobile communication terminal is received and reads x-coordinate values and y-coordinate values of corresponding base stations from the base station information database, and determines an x-coordinate value of the mobile communication terminal by calculating a mean value of the x-coordinate values of the base stations and a y-coordinate value of the mobile communication terminal by calculating a mean value of the y-coordinate values of the base stations.

According to another aspect of the present invention, there is provided a method for determining a position of a mobile communication terminal by a location server including a database storing x-coordinate values and y-coordinate values corresponding to a position of each base station in an assisted global positioning system (AGPS), the method including receiving a base station measurement signal provided by the mobile communication terminal, reading x-coordinate values and y-coordinate values of corresponding base stations if the base station measurement signal is received, and determining an x-coordinate value of the mobile communication terminal by calculating a mean value of the x-coordinate values of the base stations and a y-coordinate value of the mobile communication terminal by calculating a mean value of the y-coordinate values of the base stations.

The mean value is obtained through arithmetic mean or weighted mean. Coordinates of sector centers of the base stations may be used instead of the coordinates of the base stations.

### BRIEF DESCRIPTION OF THE DRAWINGS

The above and other objects, features and advantages of the present invention will be more apparent from the following detailed description taken in conjunction with the accompanying drawings, in which:

FIG. 1 illustrates a structure of an assisted global positioning system (AGPS) according to the present invention;

FIG. 2 is a flow diagram illustrating a detailed procedure of exchanging a message (Me) between a mobile communication terminal and a location server in the AGPS system applicable to the present invention;

FIG. 3 is a block diagram illustrating a relationship between a mobile communication terminal according to a preferred embodiment of the present invention and a location server;

FIG. 4 is a graph illustrating a method for determining the position of a mobile communication terminal according to a preferred embodiment of the present invention; and

FIG. 5 is a graph illustrating a method for determining the position of a mobile communication terminal according to another preferred embodiment of the present invention.

### DETAILED DESCRIPTION OF THE PREFERRED EMBODIMENT

Hereinafter, preferred embodiments of the present invention will be described in detail with reference to the accompanying drawings. Note that the same or similar components in drawings are designated by the same reference numerals as far as possible although they are shown in different drawings. Although many specific items such as detailed coordinate values are shown in the following description, these are provided only for the purpose of overall comprehension about the present invention. Therefore, it is generally known to those skilled in the art that the present invention can be embodied without being limited by the specific items. In the following description of the present invention, a detailed description of known functions and configurations incorporated herein will be omitted when it may make the subject matter of the present invention unclear.

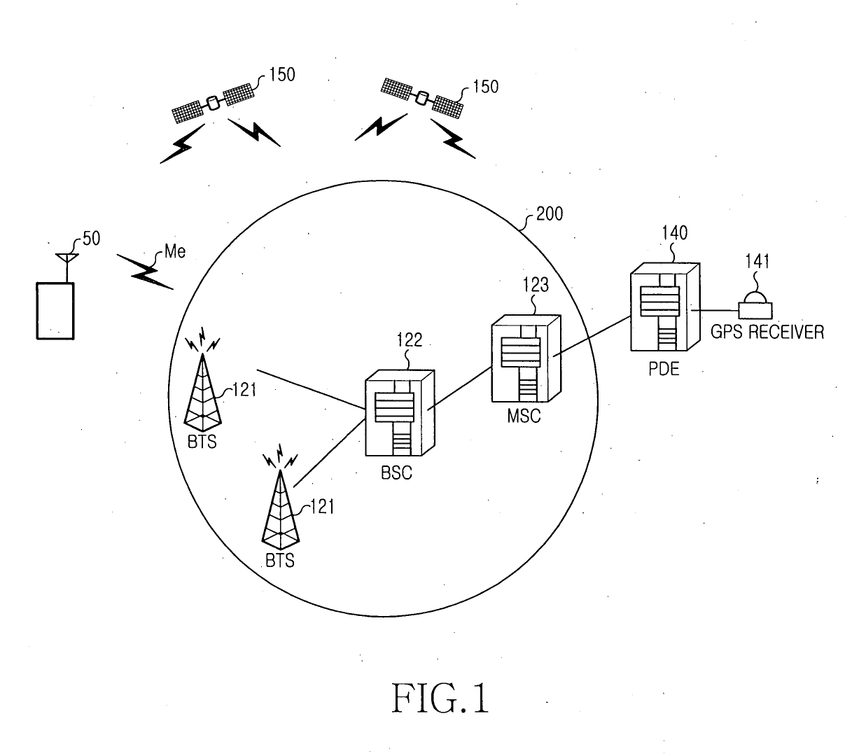

FIG. 1 illustrates a structure of an assisted global positioning system (AGPS) according to the present invention, and it is assumed that a code division multiple access (CDMA) system is employed.

A mobile communication terminal 50 can wirelessly communicates with a base station transceiver subsystem (BTS) 121 of a mobile communication system 200. In addition, the mobile communication terminal 50 includes a GPS receive antenna and can therefore receive a GPS signal. A location server 140 communicates with the BTS 121 and is equipped with a reference station GPS receiver 141. If the mobile communication terminal 50 requests the determination of its position or if the location server 140 requests the determination of the position of the mobile communication terminal 50, the mobile communication terminal 50 provides a base station measurement signal to the location server 140. The location server 140 determines an initial position of the mobile communication terminal 50 based on the base station measurement signal so as to provide acquisition assistance data to the mobile communication terminal 50. The mobile communication terminal 50 measures information about a GPS pseudo range using the acquisition assistance data and provides the information about a GPS pseudo range to the location server 140.

The location server 140 determines the final position of the mobile communication terminal 50 using information about the GPS pseudo range provided by the mobile communication terminal 50 and base station information belonging to the location server 140. However, the location server 140 may selectively determine whether to provide the final position with the mobile communication terminal 50. For example, in a case of an urgent service (e.g., an emergency communication), the location server 140 may not provide the final position of the mobile communication terminal 50 to the mobile communication terminal 50.

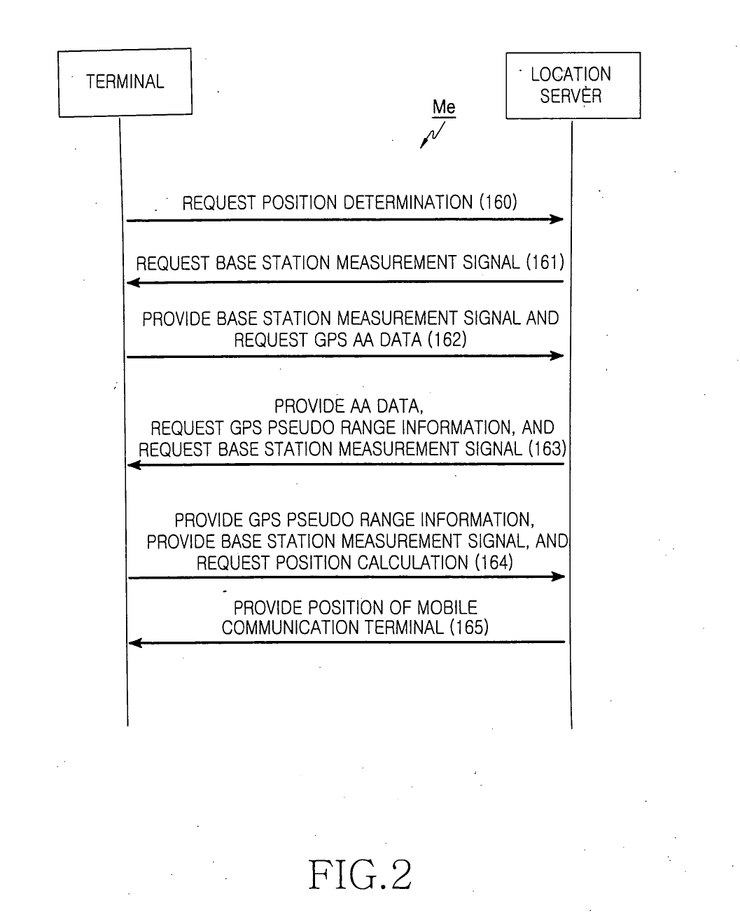

FIG. 2 is a flow diagram illustrating a detailed procedure of exchanging a message (Me) between the mobile communication terminal 50 and the location server 140 shown in FIG. 1 in the AGPS system according to the present invention.

If a mobile communication terminal 50 requests the determination of its position from the location server 140 (at Step 160), the location server 140 requests the base station measurement signal from the mobile communication terminal 50 (Step 161). The request for the base station measurement signal contains an indication that the mobile communication terminal 50 provides pilot phase measurement information to the location server 140.

The mobile communication terminal 50 requests GPS acquisition assistance (at Step 162) and provides the base station measurement signal to the location server 140 in response to the request for the base station measurement signal.

The base station measurement signal provided by the mobile communication terminal 50 includes pilot phase information in accordance with a TDOA scheme) and information including a system identification (ID), a network ID, a base station ID, and a sector ID which can classify each base station according to sectors.

In response to the request for GPS acquisition assistance data of the mobile communication terminal 50, the location server 140 calculates the initial position of the mobile communication terminal 50 based on the base station measurement signal provided by the mobile communication terminal and generates GPS acquisition assistance data to be provided to the mobile communication terminal 50 based on the calculated initial position (at Step 163). The GPS acquisition assistance data includes a specific time point, a Satellite Vehicle (SV) code phase for pseudo range information of each satellite at the specific time point, and a search window based on the SV code phase.

The mobile communication terminal 50 searches the range of the search window based on the SV code phase for pseudo-range information by using acquisition assistance provided by the location server 140 so as to measure GPS pseudo-range (the value of the measured pseudo range is called pseudo range measurement (PRM) and measures base station measurement signal again (wherein the measured value is called PPM) so as to provide the PRM to the location server 140 (step 164).

The location server 140 calculates the position of the mobile communication terminal 50 using the PRM. If the location server 140 cannot calculate the position of the mobile communication terminal 50 using only the PRM, the location server 140 calculates the position of the mobile communication terminal 50 using the PRM together with the PPM and then provides the calculated result to the mobile communication terminal 50 (at Step 165).

The position calculation performed at Step 163 may be achieved through one of the following four position calculation schemes according to one embodiment of the present invention. In addition, when the position of the mobile communication terminal cannot be calculated even using the PPM in step 165, the position of the mobile communication terminal is re-calculated based on a newly received base station measurement signal in step 164. In this case, one of the following four position calculation schemes according to one embodiment of the present invention may be employed.

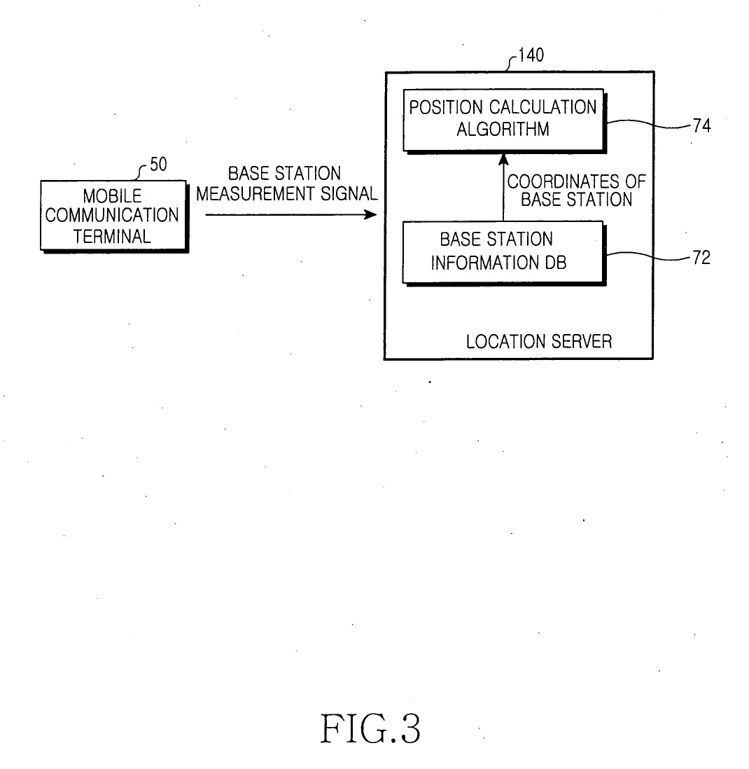

FIG. 3 is a block diagram illustrating a relationship between the mobile communication terminal 50 according to a preferred embodiment of the present invention and the location server 140 for determining the position of the mobile communication terminal 50.

If a base station measurement signal is transmitted to the location server 140 from the mobile communication terminal 50, the location server 140 can read the coordinate value of the base station stored in a base station information database 72 based on PPM information of the base station measured in the mobile communication terminal 50.

A position calculation algorithm 74 of the location server 140 is used for calculating the position of the mobile communication terminal 50 using the PRM information or for calculating the position of the mobile communication terminal 50 using the PPM information. In addition, the position calculation algorithm 74 includes a scheme of calculating the position of the mobile communication terminal 50 using the PPM information together with the PRM information or a scheme of calculating the position of the mobile communication terminal 50 by finding a mean value of base station coordinate values of the PPM information.

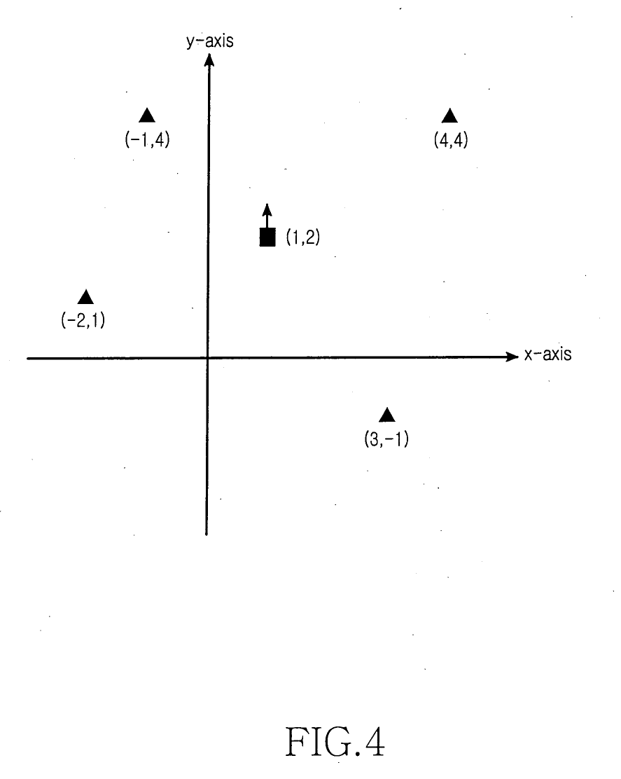

FIG. 4 is a graph illustrating a method for determining the position of the mobile communication terminal according to a preferred embodiment of the present invention.

As shown as FIG. 4, it is assumed that four base stations (depicted by triangles) are arranged so that their respective positions correspondingly to the coordinates (−1, 4), (4, 4), (−2, 1), and (3, −1).

An x-coordinate value of the mobile communication terminal 50 is determined by performing an arithmetic mean operation in which all x-coordinate values are summed up and then divided by the total number of the x-coordinates. In addition, a y-coordinate value of the mobile communication terminal 50 is determined by performing an arithmetic mean of y-coordinate values of the base station in a similar fashion. In other words, a coordinate MS (x, y) of the mobile communication terminal 50 can be using an arithmetic mean coordinate of the base station as shown in Equation 1.

$$MS ( x , y ) = ( \frac{1}{N} {\sum }_{i = 1}^{{N}_{ES}} {BSx}_{i} , \frac{1}{N} {\sum }_{i = 1}^{{N}_{BS}} {BSy}_{i} ) \qquad Equation ( 1 )$$

Herein, the N is the number of base stations measured by the mobile communication terminal 50, and the BSxᵢ and the BSyᵢ respectively represent an x-coordinate value and a y-coordinate value. Accordingly, the x-coordinate value of the mobile communication terminal 50 is (−1−2+3+4)/4=1, and the y-coordinate value of the mobile communication terminal 50 is (+4+1−1+4)/4=2. In other words, MS(1,2) becomes the calculated coordinate of the mobile communication terminal 50.

Although description about the coordinates of the base station is briefly given for the purpose of description, a geographic coordinate system, a plane coordinate system such as an east north up (ENU) coordinate system, and an earth-centered earth fixed (ECEF) coordinate system may be employed as coordinates of the mobile communication terminal and the base station in order to practically realize the coordinates of the base station. Transformation between coordinate systems can be achieved through simple calculation.

The following weighted mean may be considered in addition to the arithmetic mean in order to realize the coordinates of the base station

First, a weight value is given to coordinates of a serving base station, This reflects that probability, in which the mobile communication terminal exists in an area covered by the serving base station, is high.

When it is assumed that a base station in coordinates (−1, 4) shown in the embodiment is a serving base station, a scheme for giving a weight value (for example, a weight of 2) to the serving base station is as follows. An x-coordinate value of the mobile communication terminal is (−1*2−2+3+4)/(4+1)=0.6, and a y-coordinate value of the mobile communication terminal is (4*2+1−1+4)/(4+1)=2.4. In other words, MS (0.6, 2.4) becomes the calculated coordinate of the mobile communication terminal 50. This scheme is an example, in which a weight value is employed such that the position of MS (0.6, 2.4) is closer to the position of the serving base station than the position of MS (1, 2) obtained through a scheme of using base station mean coordinates. In other words, the x, y-coordinate values obtained by this scheme are equal to those obtained by another scheme for having two serving base stations whose weight is 1. Therefore, an equation of calculating x-coordinate weight becomes ‘(−1−1−2+3+4)/(1+1+1+1+1)=0.6’

Second, a weight value is applied using pilot signal strength measured in the mobile communication terminal. This scheme is based on the fact that the base station can be positioned nearer to a mobile communication terminal as the pilot signal strength thereof becomes increased.

According to the second scheme, the weight is employed using information regarding a pilot signal included in PPM information measured by the mobile communication terminal 50. On the assumption that pilot signals measured by the mobile communication terminal 50 have the strength (STR) of −10 dB, −15 dB, −20 dB, and −20 dB, respectively, counterclockwise from a base station in the coordinates (−1, 4), the application of a weight value is as follows. Since the minimum value of an STR value measured by the mobile communication terminal is −32 dB, the weight value is calculated as an absolute value of a value obtained by subtracting an STR value of each base station from −32 dB. In other words, since an STR value of a serving base station is −10 dB, the weight value becomes 22 which is an absolute value of (−32−(−15)). Similarly, the weights obtained based on STR values of remaining neighboring base stations equal to absolute values of (−32−(−15)), (−32−(−20)), and (−32−(−25)), that is, 17, 12 and 7, respectively. Therefore, an x-coordinate value of the mobile communication terminal is 0.14 resulting from ((−1*22−2*17+3*12+4*7)/(22+17+12+7)), and a y-coordinate value is 2.09 resulting from ((4*22+1*17−1*12+4*7)/(22+17+12+7)). In other words, MS(0.14, 2.09) becomes the calculated coordinate of the mobile communication terminal. In comparison with the coordinates of MS(1,2) obtained by using a mean coordinate of the base station, the coordinates of MS(0.14, 2.09) obtained through this second scheme represent the coordinates of the mobile communication terminal obtained by applying the weight while taking the influence of the STR of a pilot signal into consideration.

Third, a weight value is applied using root mean square (RMS) of a PPM value of the base station measured in the mobile communication terminal. This scheme is based on the fact that as an RMS value of a PPM value becomes greater, the probability of receiving the signal from a base station remote from the mobile communication terminal may increase.

When an RMS value of the coordinates (−1,4) of a serving base station is 10, and when RMS values of remaining base station are 20, 30, and 40, respectively, counterclockwise from the coordinates (−1,4) in the coordinate system shown in FIG. 4, since the higher RMS represents that a greater number of errors exist in the PPM information of a corresponding base station, the application of a weight value is as follows. An x-coordinate value of the mobile communication terminal 50 is 0 resulting from (− 1/10− 2/20+ 3/30+ 4/40)/( 1/10+ 1/20+ 1/30+ 1/40), and a y-coordinate value of the mobile communication terminal 50 is 2.48 resulting from (( 4/10+ 1/20− 1/30+ 4/40)/( 1/10+ 1/20+ 1/30+ 1/40)). In other words, the coordinates of the mobile communication terminal 50 become MS (0, 2.48). In comparison with the coordinates of MS(1,2) obtained by using a mean coordinate of the base station, the coordinates of MS(0, 2.48) obtained through this third scheme represent the coordinates of the mobile communication terminal obtained by applying the weight value while taking the influence of the RMS into consideration.

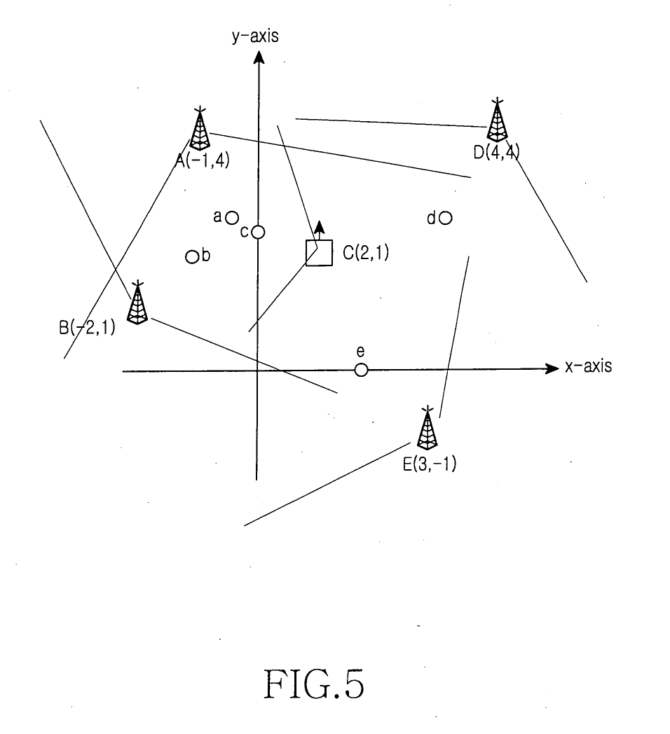

FIG. 5 is a graph illustrating a method for determining the position of the mobile communication terminal according to another preferred embodiment of the present invention.

Reference numerals A, B, C, D, and E represent coordinates of base stations, respectively, and reference numeral a, b, C, d, and e represent center coordinates of sectors of the base stations, respectively. Lines represent sectors of corresponding base stations. For example, an area having about 120 degrees formed by both side lines (i.e., the lines projecting from base station A as shown) of the base station A represent one of three sectors belonging to the base station A. The center coordinates of the sector corresponds to reference numeral a.

The schemes described above may be performed using center coordinates of sectors of base stations shown in FIG. 5 instead of coordinates of base stations shown in FIG. 4.

For example, the position of the mobile communication terminal 50 may be determined through arithmetic mean using center coordinates of sectors of base stations. In other words, an x-coordinate value of the mobile communication terminal 50 is determined through arithmetic mean of x-coordinate values of center coordinates of sectors in each base station, and a y-coordinate value of the mobile communication terminal 50 is determined through arithmetic mean of y-coordinate values of center coordinates of sectors in each base station.

Similarly, remaining schemes may be achieved using center coordinates of sectors of base stations shown in FIG. 5 instead of coordinates of base stations shown in FIG. 4.

As described above, advantages of to the present invention include:

First, the present invention decreases the necessary time and/or the number of calculations required for generating acquisition assistance data of a mobile communication terminal by using an algorithm for calculating the position of the mobile communication terminal, thereby reducing Time-To-First-Fix (TTFF). Second, the initial coordinates of the mobile communication terminal to be primarily used for generating acquisition assistance data may be obtained in a stable and reliable degree (having a position error of about 500 to 2000 m) through a simple operation. and Third, coordinates representing the position of the mobile communication terminal determined according to an embodiment of the present invention may be used as reference of determining if the position of the mobile communication terminal determined through the GPS or the TDOA is normally converged.

While the invention has been shown and described with reference to certain preferred embodiments thereof, it will be understood by those skilled in the art that various changes in form and details may be made therein without departing from the spirit and scope of the invention. Consequently, the scope of the invention should not be limited to the embodiments, but should be defined by the appended claims and equivalents thereof.

What is claimed is:

1. A location server for determining a position of a mobile communication terminal in an Assisted Global Positioning System (AGPS), the location server comprising:
a position calculating algorithm; and
a base station information database,
wherein the location server executes the position calculating algorithm when a base station measurement signal provided by the mobile communication terminal is received and reads x-coordinate values and y-coordinate values of corresponding base stations from the base station information database, and determines an x-coordinate value of the mobile communication terminal by calculating a mean value of the x-coordinate values of the base stations and a y-coordinate value of the mobile communication terminal by calculating a mean value of the y-coordinate values of the base stations.

2. The location server as claimed in claim 1, wherein the x-coordinate values and the y-coordinate values of the corresponding base stations are read from the base station information database based on a base station pilot phase measurement information measured by the mobile communication terminal.

3. The location server as claimed in claim 1, wherein the x-coordinate value of the mobile communication terminal is determined by calculating an arithmetic mean value of the x-coordinate values of the base stations and the y-coordinate value of the mobile communication terminal is determined by calculating an arithmetic mean value of the y-coordinate values of the base stations.

4. The location server as claimed in claim 1, wherein the x-coordinate value of the mobile communication terminal is determined by calculating a weighted mean of the x-coordinate values of the base stations, and the y-coordinate value of the mobile communication terminal is determined by calculating a weighted mean of the y-coordinate values of the base stations.

5. The location server as claimed in claim 4, wherein the x-coordinate value of the mobile communication terminal is determined by adding a sum of all x-coordinate values of the base stations for which the base station measurement signal is provided, except for a serving base station, to a value obtained by multiplying an x-coordinate value of the serving base station by 2, and then dividing a resultant value by N+1 (where N is the number of the base stations for which the base station measurement signal is provided), and the y-coordinate value of the mobile communication terminal is determined by adding a sum of all y-coordinate values of base stations, except for the serving base station, to a value obtained by multiplying an x-coordinate value of the serving base station by 2, and then dividing a resultant value by N+1.

6. The location server as claimed in claim 4, wherein the x-coordinate value of the mobile communication terminal is determined by calculating a sum of x-coordinate values of base stations multiplied by corresponding weights and then dividing a resultant value by a sum of the preset weights, and the y-coordinate value of the mobile communication terminal is determined by calculating a sum of y-coordinate values of the base stations multiplied by corresponding weights and then dividing a resultant value by a sum of the preset weights.

7. The location server as claimed in claim 6, wherein the weights are absolutes of values obtained by subtracting pilot signal strength values of the base stations provided through the base station measurement signal from a minimum pilot signal strength value.

8. The location server as claimed in claim 6, wherein the weights are reciprocals of root mean square (RMS) values of the base stations provided by the base station measurement signal.

9. A method for determining a position of a mobile communication terminal using a location server including a database for storing x-coordinate values and y-coordinate values corresponding to a position of each base station in an Assisted Global Positioning System (AGPS), the method comprising the steps of:
receiving a base station measurement signal provided by the mobile communication terminal;
reading x-coordinate values and y-coordinate values of corresponding base stations, if the base station measurement signal is received; and
determining an x-coordinate value of the mobile communication terminal by calculating a mean value of the x-coordinate values of the base stations and a y-coordinate value of the mobile communication terminal by calculating a mean value of the y-coordinate values of the base stations.

10. The method as claimed in claim 9, wherein, in the step of determining the x-coordinate value and the y-coordinate value of the mobile communication terminal, the x-coordinate value of the mobile communication terminal is determined by calculating an arithmetic mean value of the x-coordinate values of the base stations, and the y-coordinate value of the mobile communication terminal is determined by calculating an arithmetic mean value of the y-coordinate values of the base stations.

11. The method as claimed in claim 10, wherein a geographic coordinate system, an East North Up (ENU) coordinate system, or an Earth-Centered Earth-Fixed (ECEF) coordinate system is employed for determining coordinates of the mobile communication terminal and the base station.

12. The method as claimed in claim 9, wherein, in the step of determining the x-coordinate value and the y-coordinate value of the mobile communication terminal, the x-coordinate value of the mobile communication terminal is determined by calculating a weighted mean of the x-coordinate values of the base stations, and the y-coordinate value of the mobile communication terminal is determined by calculating a weighted mean of the y-coordinate values of the base stations.

13. The method as claimed in claim 12, wherein, in the step of determining the x-coordinate value and the y-coordinate value of the mobile communication terminal, the x-coordinate value of the mobile communication terminal is determined by adding a sum of all x-coordinate values of the base stations for which the base station measurement signal is provided, except for a serving base station, to a value obtained by multiplying an x-coordinate value of the serving base station by 2, and then dividing a resultant value by N+1 where N is the number of the base stations for which the base station measurement signal is provided, and the y-coordinate value of the mobile communication terminal is determined by adding a sum of all y-coordinate values of base stations, except for the serving base station, to a value obtained by multiplying an x-coordinate value of the serving base station by 2, and then dividing a resultant value by N+1.

14. The method as claimed in claim 12, wherein, in the step of determining the x-coordinate value and the y-coordinate value of the mobile communication terminal, the x-coordinate value of the mobile communication terminal is determined by calculating a sum of x-coordinate values of base stations, multiplied by corresponding weights and then dividing a resultant value by a sum of the preset weights, and the y-coordinate value of the mobile communication terminal is determined by calculating a sum of y-coordinate values of the base stations multiplied by corresponding weights and then dividing a resultant value by a sum of the preset weights.

15. The method as claimed in claim 14, wherein the weights are absolutes of values obtained by subtracting pilot signal strength values of the base stations provided through the base station measurement signal from a minimum pilot signal strength value.

16. The method as claimed in claim 15, wherein the pilot signal strength values are included in pilot phase measurement information of the base station measurement signal.

17. The method as claimed in claim 14, wherein the weights are reciprocals of root mean square values of the base stations provided by the base station measurement signal.

18. The method as claimed in claim 17, wherein the root mean square values are included in pilot phase measurement information of the base station measurement signal.

19. A location server for determining a position of a mobile communication terminal in an Assisted Global Positioning System (AGPS), the location server comprising:
a position calculating algorithm; and
a base station information database,
wherein the location server executes the position calculating algorithm when a base station measurement signal provided by the mobile communication terminal is received, reads x-coordinate values and y-coordinate values of sector centers of corresponding base stations from the base station information database, and determines an x-coordinate value of the mobile communication terminal by calculating a mean value of the x-coordinate values of the sector centers of the corresponding base stations and a y-coordinate value of the mobile communication terminal by calculating a mean value of the y-coordinate values of the sector centers of the corresponding base stations.

20. The location server as claimed in claim 19, wherein the x-coordinate values and the y-coordinate values of the sector centers of the corresponding base stations are read from the base station information database based on pilot phase measurement information of a base station measured by the mobile communication terminal.

21. The location server as claimed in claim 19, wherein the x-coordinate value of the mobile communication terminal is determined by calculating an arithmetic mean value of the x-coordinate values of the sector centers of the base stations and the y-coordinate value of the mobile communication terminal is determined by calculating an arithmetic mean value of the y-coordinate values of the sector centers of the base stations.

22. The location server as claimed in claim 19, wherein the x-coordinate value of the mobile communication terminal is determined by calculating a weighted mean of the x-coordinate values of the sector centers of the base stations and the y-coordinate value of the mobile communication terminal is determined by calculating a weighted mean of the y-coordinate values of the sector centers of the base stations.

23. The location server as claimed in claim 22, wherein the x-coordinate value of the mobile communication terminal is determined by adding a sum of all x-coordinate values of sector centers of the base stations for which the base station measurement signal is provided, except for a serving base station, to a value obtained by multiplying an x-coordinate value of the serving base station by 2, and then dividing a resultant value by N+1, where N is the number of the base stations for which the base station measurement signal is provided, and the y-coordinate value of the mobile communication terminal is determined by adding a sum of all y-coordinate values of sector centers of base stations, except for the serving base station, to a value obtained by multiplying an x-coordinate value of the sector center of the serving base station by 2, and then dividing a resultant value by N+1.

24. The location server as claimed in claim 22, wherein the x-coordinate value of the mobile communication terminal is determined by calculating a sum of x-coordinate values of sector centers of base stations multiplied by corresponding weights and then dividing a resultant value by a sum of the preset weights, and the y-coordinate value of the mobile communication terminal is determined by calculating a sum of y-coordinate values the sector centers of the base stations multiplied by corresponding weights and then dividing a resultant value by a sum of the preset weights.

25. The location server as claimed in claim 24, wherein the weights are absolutes of values obtained by subtracting pilot signal strength values of the base stations provided through the base station measurement signal from a minimum pilot signal strength value.

26. The location server as claimed in claim 24, wherein the weights are reciprocals of root mean square values of the base stations provided by the base station measurement signal.

27. A method for determining a position of a mobile communication terminal by a location server including a database storing x-coordinate values and y-coordinate values of sector centers of base stations in an Assisted Global Positioning System (AGPS), the method comprising the steps of:
receiving a base station measurement signal provided by the mobile communication terminal;
reading x-coordinate values and y-coordinate values of sector centers of corresponding base stations, if the base station measurement signal is received; and
determining an x-coordinate value of the mobile communication terminal by calculating a mean value of the x-coordinate values of the sector centers of the base stations and a y-coordinate value of the mobile communication terminal by calculating a mean value of the y-coordinate values of the sector centers of the base stations.

28. The method as claimed in claim 27, wherein, in the step of determining the x-coordinate value and the y-coordinate value of the mobile communication terminal, the x-coordinate value of the mobile communication terminal is determined by calculating an arithmetic mean value of the x-coordinate values of the sector centers of the base stations, and the y-coordinate value of the mobile communication terminal is determined by calculating an arithmetic mean value of the y-coordinate values of the sector centers of the base stations.

29. The method as claimed in claim 28, wherein a geographic coordinate system, an East North Up (ENU) coordinate system, or an Earth-Centered Earth Fixed (ECEF) coordinate system is employed for coordinates of the mobile communication terminal and the base station.

30. The method as claimed in claim 27, wherein, in the step of determining the x-coordinate value and the y-coordinate value of the mobile communication terminal, the x-coordinate value of the mobile communication terminal is determined by calculating a weighted mean of the x-coordinate values of the sector centers of the base stations, and the y-coordinate value of the mobile communication terminal is determined by calculating a weighted mean of the y-coordinate values of the sector centers of the base stations.

31. The method as claimed in claim 30, wherein, in the step of determining the x-coordinate value and the y-coordinate value of the mobile communication terminal, the x-coordinate value of the mobile communication terminal is determined by adding a sum of all x-coordinate values of centers of the base station sectors for which the base station measurement signal is provided, except for a serving base station, to a value obtained by multiplying an x-coordinate value of the serving base station by 2, and then dividing a resultant value by N+1, where N is the number of the base stations for which the base station measurement signal is provided, and the y-coordinate value of the mobile communication terminal is determined by adding a sum of all y-coordinate values of centers of base station sectors, except for the serving base station, to a value obtained by multiplying an x-coordinate value of the center of the serving base station sector by 2, and then dividing a resultant value by N+1.

32. The method as claimed in claim 30, wherein, in the step of determining the x-coordinate value and the y-coordinate value of the mobile communication terminal, the x-coordinate value of the mobile communication terminal is determined by calculating a sum of x-coordinate values of sector centers of base stations multiplied by corresponding weights and then dividing a resultant value by a sum of the preset weights, and the y-coordinate value of the mobile communication terminal is determined by calculating a sum of y-coordinate values of sector centers of the base stations multiplied by corresponding weights and then dividing a resultant value by a sum of the preset weights.

33. The method as claimed in claim 32, wherein the weights are absolutes of values obtained by subtracting pilot signal strength values of the base stations provided through the base station measurement signal from a minimum pilot signal strength value.

34. The method as claimed in claim 33, wherein the pilot signal strength values are included in pilot phase measurement information of the base station measurement signal.

35. The method as claimed in claim 32, wherein the weights are reciprocals of root mean square values of the base stations provided by the base station measurement signal.

36. The method as claimed in claim 35, wherein the root mean square values are included in pilot phase measurement information of the base station measurement signal.
